(19) United States
(12) Patent Application Publication
(10) Pub. No.: US 2015/0309732 A1
(43) Pub. Date: Oct. 29, 2015

(54) Selectively Configuring Hard-Disk Drive System

(71) Applicant: LSI Corporation, San Jose, CA (US)

(72) Inventors: Senthil Kumar Kangayampalayam Kandasamy, Bangalore (IN); Ankit Goel, Bangalore (IN); Nishant Kumar Yadav, Bangalore (IN); Rakesh Cherukuri, Bangalore (IN); Saulat Ullah Zuberi, Bangalore (IN)

(21) Appl. No.: 14/299,052

(22) Filed: Jun. 9, 2014

(30) Foreign Application Priority Data
Apr. 28, 2014 (IN) 2135/CHE/2014

(51) Int. Cl. G06F 3/06

(52) U.S. Cl. CPC G06F 3/0607; G06F 3/0679; G06F 3/0632; G06F 3/0659; G06F 2206/1014

(57) ABSTRACT

In one embodiment of the disclosure, a hard-disk drive (HDD) controller for an HDD system is selectively configurable to operate with a first type of host system having a first logical block size and a second type of host system having a second logical block size, different from the first logical block size. Another embodiment of the disclosure is a method implemented by the HDD system.

### FIELD OF INVENTION

The present invention relates to hard-disk drive systems, and, more specifically but not exclusively, to the storage of data on hard-disk drives.

### BACKGROUND

Conventional hard-disk drive (HDD) systems contain one or more hard-disk platters. Each platter is partitioned into concentric rings called tracks, and each track is further partitioned into smaller sections called sectors. Each sector stores user data and overhead information that is used to recover the user data. Traditionally, HDD systems were implemented using 512 native (512n) formatting. In a 512n-formatted HDD system, the HDD controller is configured to receive 512-byte logical blocks of user data from the input-output (IO) controller of a host system (e.g., a computer), and each hard-disk platter is formatted such that each sector is sized to store one 512-byte physical block of user data.

With the advent of Advanced Format, newer host systems and HDD systems are being implemented to process and store user-data blocks that are larger than 512 bytes. For example, in a 4-kilobyte (4K)-formatted HDD system, the HDD controller is configured to receive 4,096-byte logical blocks of user data from the input-output (IO) controller of a host system, and each hard-disk platter is formatted such that each sector is sized to store one 4,096-byte physical block of user data.

Although newer Advanced Format HDD systems are available, many host systems are still configured to process 512-byte logical blocks. For example, the chipsets, operating systems, database engines, hard-drive partitioning and imaging tools, backup and file-system utilities, and other software applications of the host systems may assume that HDD systems are configured to process 512-byte logical blocks. To maintain compatibility between host systems that process 512-byte logical blocks of user data and newer HDD systems that store 4,096-byte physical blocks of user data, some newer HDD systems are configured to convert 512-byte logical blocks into 4,096-byte physical blocks for storage. HDD systems that are configured to receive 512-byte logical blocks and store 4,096-byte physical blocks are referred to as 512 emulation (512e) drives.

### SUMMARY

In one embodiment of the disclosure, an apparatus comprises a hard-disk drive (HDD) controller for an HDD system. The HDD controller is selectively configurable to operate with a first type of host system having a first logical block size and a second type of host system having a second logical block size, different from the first logical block size. Another embodiment of the disclosure is a method implemented by the aforementioned apparatus.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a simplified block diagram of a computer system according to one embodiment of the disclosure that comprises an HDD system and a host system;

FIG. 2 shows a simplified flow diagram of a process according to one embodiment of the disclosure that may be used to selectively configure the HDD system in FIG. 1;

FIG. 3 shows Table I, which illustrates a modified FORMAT UNIT command according to one embodiment of the disclosure;

FIG. 4 shows a simplified block diagram of a logical-physical block mapper according to one embodiment of the disclosure; and

FIG. 5 shows Table II, which illustrates five exemplary configuration scenarios that may be implemented by the computer system of FIG. 1.

### WRITTEN DESCRIPTION

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

In order for a hard-disk drive (HDD) system to properly communicate with a host system, the HDD system should be configured to receive logical blocks from the host system, and transmit logical blocks to the host system, that are the same size (e.g., 512 bytes or 4,096 bytes) as the logical blocks that are processed by the host system. Traditionally, the configuration of a hard-disk drive (HDD) system (e.g., 512n-, 512e-, or 4K-configuration) is fixed prior to connecting the HDD system to a host system (e.g., at the factory where the HDD system is assembled). Thus, when selecting an HDD system to pair with a host system, the HDD system should be selected such that the size of the logical blocks processed by the HDD system is the same as the size of the logical blocks processed by the host system.

However, since there are a number of differently configured HDD systems (e.g., 512n-, 512e-, and 4K-configured HDD systems) and a number of differently configured host systems (e.g., 512-byte systems and 4,096-byte host systems) on the market, it is very likely that HDD systems will be connected to incompatible host systems. For example, suppose that a 512e-configured HDD is connected to a host system that processes 4,096-byte logical blocks. In this case, the 512e-configured HDD system is configured to transmit 512-byte logical blocks to, and receive 512-byte logical blocks from the host system. The host system, on the other hand, is configured to transmit 4,096-byte logical blocks to, and receive 4,096-byte logical blocks from, the HDD system. Therefore, the host system and HDD system are incompatible.

To overcome this compatibility issue, there is a need for HDD systems that can be selectively configured to operate with any host system (e.g., to selectively process 512-byte logical blocks and 4,096-byte logical blocks).

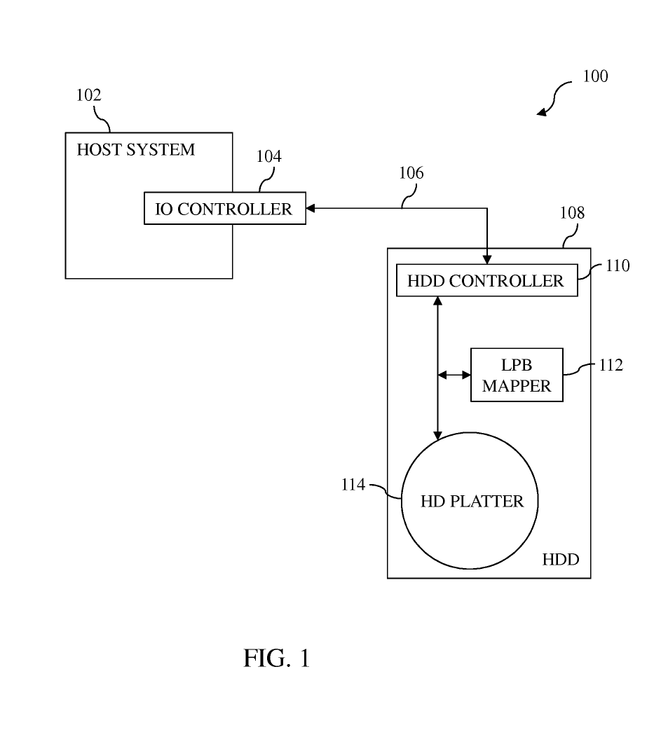

FIG. 1 shows a simplified block diagram of a computer system 100 according to one embodiment of the disclosure that comprises an HDD system 108 and a host system 102. Host system 102 may be (without limitation) a laptop computer, a desktop computer, or a server. HDD system 108 may be an external HDD system, such as a back-up drive, located externally to host system 102 as shown or an internal HDD system located within host system 102.

In general, during operation, an input-output (JO) controller 104 of host system 102 provides logical blocks to, and receives logical blocks from, an HDD controller 110 of HDD system 108 via IO cable 106. Logical blocks transmitted to HDD system 108 are mapped to the physical block size by HDD controller 110 or logical-physical block (LPB) mapper 112 and written to the hard-disk platter 114. Physical blocks read from the hard-disk platter 114 are mapped to the logical block size by HDD controller 110 or logical-physical block mapper 112, and transmitted to the host system 102.

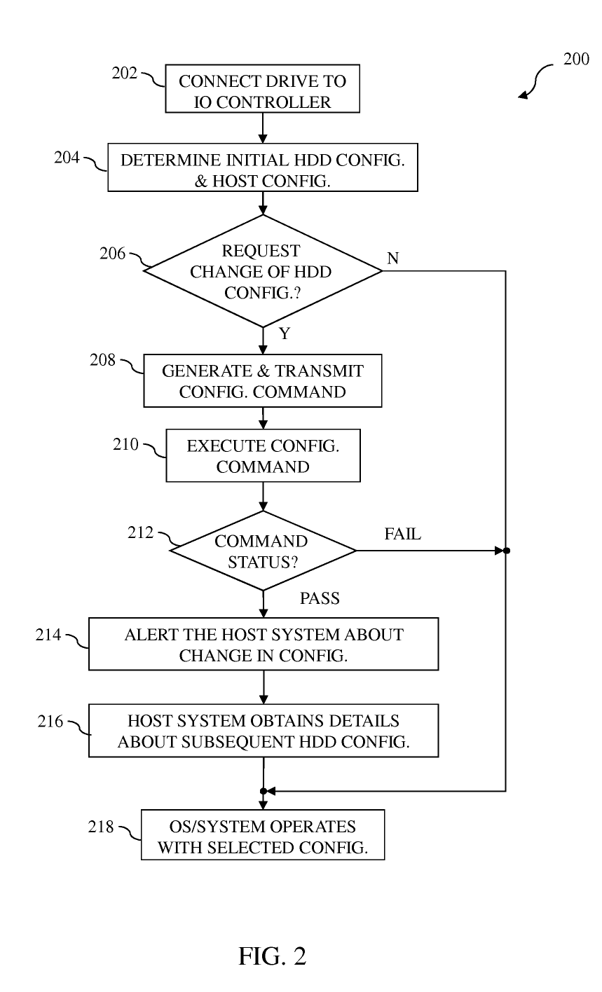

The sizes of the logical blocks and the physical blocks are determined upon connecting HDD system 108 to host system 102. Prior to being connected to host system 102 (e.g., at the factory where HDD system 108 is assembled), HDD system 108 is set to an initial configuration (e.g., 512n, 512e, or 4K). Once HDD system 108 is connected to host system 108, HDD system 108 selects a subsequent configuration. If the initial configuration is compatible with host system 102, then the initial configuration of HDD system 108 is selected as the subsequent configuration. If, on the other hand, the initial configuration is not compatible with host system 102, then the configuration of HDD system 108 is changed by selecting a subsequent configuration, different from the initial configuration, that is compatible with host system 102. The configuration may be changed by changing the conversion formulas used to (i) map logical blocks to physical blocks and (ii) physical blocks to logical blocks. Thus, HDD system 108 may be selectively configured to operate in one of a plurality of different configurations. To further understand this process, consider FIG. 2.

FIG. 2 shows a simplified flow diagram of a process 200 according to one embodiment of the disclosure that may be used to selectively configure HDD system 108 of FIG. 1. In step 202, HDD system 108 is connected to host system 102 via IO cable 106. In step 204, the initial configuration of HDD system 108 is determined. In some embodiments of the disclosure, the initial configuration may be determined by a user by, for example, reviewing the specifications of HDD system 108. In alternative embodiments of the disclosure, the initial configuration of HDD system 108 may be determined by executing the READ CAPACITY (16) command as defined in, for example, the “Small Computer System Interface (SCSI) Block Commands-3 (SBC-3)” standard by the International Committee for Information Technology Standards (INCITS)/T10, project number 1799-D, BSR number INCITS 514, revision 36, 11 Nov. 2013, the teachings of all of which are incorporated herein by reference in their entirety. An example of the READ CAPACITY (16) command is shown in Table 65 in this standard. Note that this command is also defined in other versions of the standard.

In general, the READ CAPACITY (16) command is a 16-byte message that is transmitted from IO controller 104 to HDD controller 110. In response to the READ CAPACITY (16) command, the HDD controller 110 returns a READ CAPACITY (16) parameter data message to IO controller 104. The READ CAPACITY (16) parameter data message is a 32-byte message that comprises, among other fields, (i) a LOGICAL BLOCK LENGTH IN BYTES field (i.e., bytes 8-11 of the message) and (ii) a LOGICAL BLOCK PER PHYSICAL BLOCK EXPONENT field (i.e., bits 0-3 of byte 13 of the message). The LOGICAL BLOCK LENGTH IN BYTES field is set to the size of the logical blocks processed by HDD system 108 (e.g., 512 bytes or 4,096 bytes). The LOGICAL BLOCK PER PHYSICAL BLOCK EXPONENT field is set to (i) zero when HDD system 108 processes one or more physical blocks for each logical block and (ii) n>0 when HDD system 108 processes 2ⁿ logical blocks for each physical block.

As an example, suppose that HDD system 108 is initially configured as a 512e device (i.e., 512-byte logical blocks and 4,096-byte physical blocks). In such a case, HDD controller 110 will return a READ CAPACITY (16) parameter data message to IO controller 104, where (i) the LOGICAL BLOCK LENGTH IN BYTES field is set to 512 bytes and (ii) the LOGICAL BLOCK PER PHYSICAL BLOCK EXPONENT field is set to n=3 (i.e., 2ⁿ⁼³×512-byte logical blocks=4,096-byte physical blocks). Based on the LOGICAL BLOCK LENGTH IN BYTES field being set to 512 bytes and the LOGICAL BLOCK PER PHYSICAL BLOCK EXPONENT field being set to n=3, the host system 102 can recognize that the initial configuration of HDD system 108 is the 512e configuration (i.e., 512-byte logical blocks and 4,096-byte physical blocks).

In step 206, a determination is made as to whether or not host system 102 should request HDD system 108 to change configurations. This determination may be made by comparing the initial configuration determined in step 204 to the configuration of host system 102. This comparison may be made by, for example, the user or by an application run by host system 102.

As an example, suppose that HDD system 108 is initially configured as a 512e device as described above. If host system 102 is configured to processes 512-byte logical blocks, similar to HDD system 108, then the initial configuration is not changed (i.e., the initial configuration is selected as the subsequent configuration), and HDD system 108 is operated in step 218 using the initial configuration. Note that, when using the initial configuration, the mapping of logical blocks to physical blocks, and vice versa, may be handled by the logical-physical block mapper 112 discussed below or a separate logical-physical block mapper (not shown) within HDD system 108 or HDD controller 108. If, on the other hand, host system 102 is configured to process 4,096 logical blocks, unlike HDD system 108, then it is determined in step 206 that the initial configuration should be changed and processing proceeds to step 208.

In step 208, IO controller 104 generates a configuration command and transmits the configuration command to HDD controller 110 to instruct HDD controller 110 to select a subsequent configuration of HDD system 108. Generation of the configuration command may be initiated by, for example, a user or by an application run on host system 102. In some embodiments of the disclosure, the configuration command may be a modified version of the FORMAT UNIT command defined in the SBC-3 standard, an example of which is shown in Table 34 of the standard. In alternative embodiments, the configuration command may be implemented using another command, including (without limitation) another SCSI command.

In general, the FORMAT UNIT command is a 6-byte message that determines how a hard-disk platter will be prepared for use. Byte 2 of the FORMAT UNIT command is vendor specific, meaning that the vendor can determine the particular information, if any, that is transmitted over byte 2. Thus, byte 2 can be modified to instruct HDD controller 110 to change the configuration of HDD system 108.

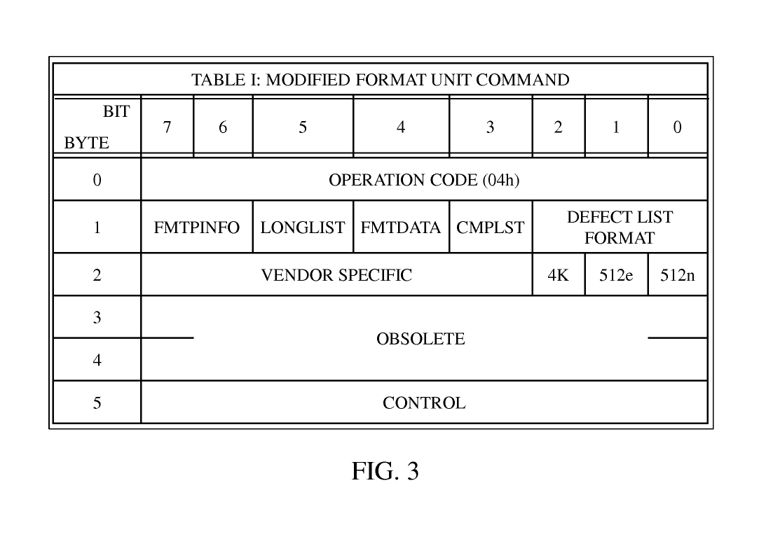

FIG. 3 shows Table I, which illustrates a modified FORMAT UNIT command according to one embodiment of the disclosure. In this embodiment, bits 0, 1, and 2 of byte 2 are assigned to the 512n, 512e, and 4K configurations, respectively. Thus, HDD controller 110 can be instructed to configure HDD system 108 as (i) a 512n device by setting bit 0 of byte 2 to a value of one and bits 1 and 2 to a value of zero, (ii) a 512e device by setting bit 1 of byte 2 to a value of one and bits 0 and 2 to a value of zero, and (iii) a 4K device by setting bit 2 of byte 2 to a value of one and bits 0 and 1 to a value of zero. The setting of bits 0, 1, and 2 may be performed by, for example, an application run on host system 102.

In alternative embodiments, as few as one bit may be used to reconfigure HDD controller 110. For example, the physical block size may be fixed (e.g., to 512-bytes or 4,096 bytes), and one bit may be set to (i) 0 or 1 to instruct HDD controller 110 to configure HDD system 108 to process 512-byte logical blocks or (ii) 1 or 0 to instruct HDD controller 110 to configure HDD system 108 to process 4,096-byte logical blocks. As another example, a first bit may be used for 512-byte logical blocks and a second bit may be used for 4,096-byte logical blocks.

Referring back to FIG. 2, in step 210, HDD controller 110 of FIG. 1 executes the configuration command generated in step 208 (e.g., the modified FORMAT UNIT command). If the configuration of HDD system 108 is changed, then logical-physical block mapper 112 of FIG. 1 changes the conversion formulas used to (i) map logical blocks to physical blocks and (ii) map physical blocks to logical blocks as discussed in further detail below. Note that logical-physical block 112 may be external to HDD controller 110 as shown or part of HDD controller 110. In some embodiments, HDD controller 110 and logical-physical block mapper 112 may be implemented on a single system on a chip.

In step 212, HDD controller 110 determines the status of the configuration command. If the configuration command is not executed properly (e.g., because the drive is not in a state to respond to the command or the bits in the configuration command are not set correctly), then the initial configuration of HDD system 108 is not changed. If, on the other hand, the configuration command is executed properly, then HDD controller 110 alerts host system 102 about the change in configuration of HDD system 108 in step 214.

In step 216, host system 102 obtains information about the subsequent configuration of HDD system 108 (e.g., physical block size, logical block size, and logical block per physical block exponent n). This may be accomplished by executing the READ CAPACITY (16) command in a manner similar to that described above in relation to step 204. Note that the physical block size may be derived from the logical block size and the logical block per physical block exponent n.

In some embodiments of the disclosure, HDD controller 110 can be configured to modify the READ CAPACITY (16) parameter data message that is returned to host system 102 in response to the READ CAPACITY (16) command. For example, one bit of the READ CAPACITY (16) parameter data message (e.g., bit 4 of byte 12) may be designated as an emulation bit that is set to (i) a value of one when a subsequent configuration is selected and (ii) a value of zero when the initial configuration is used. This bit would indicate to other applications and/or the user that the configuration of the HDD system 108 has changed.

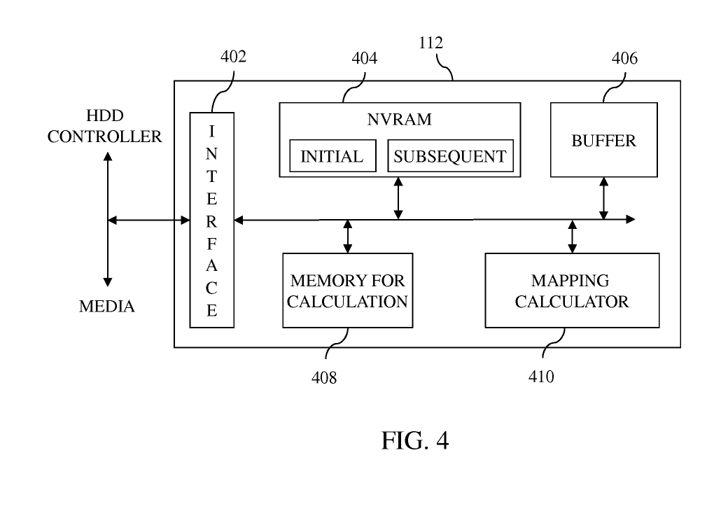

Once host system 102 receives the subsequent-configuration information, host system 102 and HDD system 108 operate with the selected configuration in step 218. In so doing, logical-physical block mapper 112 performs the mapping of (i) logical blocks to physical blocks and (ii) physical blocks to logical blocks. To further understand the operation of logical-physical block mapper 112, consider FIG. 4.

FIG. 4 shows a simplified block diagram of logical-physical block mapper 112 according to one embodiment of the disclosure. Logical-physical block mapper 112 comprises memory 404, which may be implemented using, for example, non-volatile random access memory (NVRAM). Memory 404 stores information about the initial configuration of HDD drive 108 (e.g., physical block size, logical block size, and logical block per physical block exponent n). If step 204 of FIG. 2 is implemented using the READ CAPACITY (16) command as described above, then logical-physical block mapper 112 provides the initial-configuration information stored in memory 404 via interface 402 to HDD controller 110, which in turn provides the information via IO cable 106 to host system 102 of FIG. 1.

When a change to a subsequent configuration is executed by HDD controller 110 of FIG. 1 in step 210, memory 404 receives information about the subsequent configuration (e.g., physical block size, logical block size, and logical block per physical block exponent n) from HDD controller 110 via interface 402 and stores the subsequent-configuration information. If step 216 of FIG. 2 is implemented using the READ CAPACITY (16) command, then the subsequent-configuration information is provided via interface 402 to HDD controller 110, which in turn provides the information via IO cable 106 to host system 102.

When the configuration of HDD system 108 is changed in step 210 of FIG. 2, logical-physical block mapper 112 changes (i) the logical block-to-physical block conversion formula used for converting logical blocks to physical blocks and (ii) the physical block-to-logical block conversion formula used for converting physical blocks to logical blocks. Note that mapping calculator 410 may be implemented using dedicated hardware or a general purpose processor running software.

As an example, suppose that HDD drive 108 is initially configured as a 512n drive. In this case, HDD drive 108 is configured to map 512-byte logical blocks to 512-byte physical blocks (a conversion ratio of 1:1), and vice versa. Thus, the formulas for converting (i) logical blocks to physical blocks and (ii) physical blocks to logical blocks in this configuration are as shown in Equations (1) and (2), respectively:

host block size/1=storage block size (1)

storage block size×1=host block size (2)

These conversion ratios or formulas are stored in memory 408.

Now suppose that host system 102 is a device that is configured to transmit and receive 4,096 logical blocks. In such a case, when HDD system 108 is connected to host system 102, HDD drive 108 will be reconfigured to a subsequent configuration that (i) receives 4,096-byte logical blocks from host system 102 and writes 512-byte physical blocks to platter 114 of FIG. 1 (a conversion ratio of 2ⁿ⁼³:1), and (ii) reads 512-byte physical blocks from platter 114 and transmits 4,096-byte logical blocks to host system 102 (a conversion ratio of 1:2ⁿ⁼³). The resulting formulas for converting (i) logical blocks to physical blocks and (ii) physical blocks to logical blocks in this example as are shown in Equations (3) and (4), respectively:

logical block size/8=physical block size (3)

physical block size×8=logical block size (4)

Mapping calculator 410 calculates these conversion ratios or formulas and stores them in memory 408. Mapping calculator 410 then uses these conversion ratios or formulas to determine how many logical blocks and/or physical blocks to buffer in buffer 406 during read and write operations. In particular, when a 4,096-byte logical block of user data is received from host system 102, that block will be stored in buffer 406. The 4,096-byte logical block will then be written to platter 114 from buffer 406 using eight write operations, where each write operation writes 512 bytes of the 4,096-byte logical block from buffer 406 to platter 114. Each 512-byte sub-block of the 4,096-byte logical block forms a physical block that is written to one sector of platter 114. Note that, when writing each 512-byte sub-block of user data, additional information such as (without limitation) a gap, synchronization information, and error-correction coding bits is added to the sub-block.

When a 512-byte physical block of user data is read from a sector of platter 114, the additional information discussed above will be removed, and the 512-byte block will be concatenated in buffer 406 with seven other 512-byte physical blocks read from platter 114 to form one 4,096-byte logical block that is subsequently transmitted to host system 102.

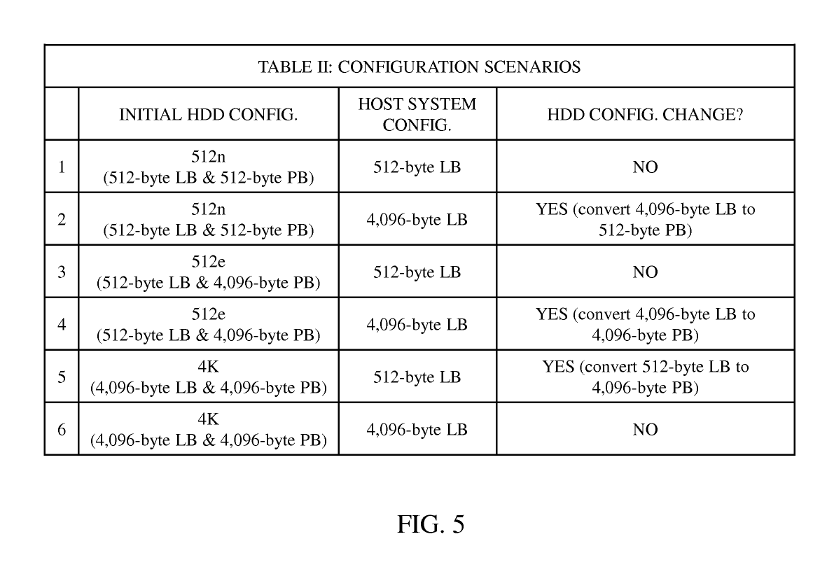

FIG. 5 shows Table II, which illustrates five exemplary configuration scenarios that may be implemented by computer system 100 of FIG. 1. In scenario 1, HDD system 108 is initially configured as a 512n device (i.e., processes 512-byte logical blocks (LBs) and stores 512-byte physical blocks (PBs)), and host system 102 is a system that processes 512-byte logical blocks. In this scenario, the initial configuration of HDD system 108 is compatible with host system 102. Therefore, the configuration of HDD system 108 is not changed.

In scenario 2, HDD system 108 is initially configured as a 512n device, and host system 102 is a system that processes 4,096-byte logical blocks. In this scenario, the initial configuration of HDD system 108 is not compatible with host system 102. Therefore, the configuration of HDD system 108 is changed such that HDD system 108 maps 4,096-byte logical blocks of host system 102 to 512-byte physical blocks of HDD system 108, and vice versa. This scenario was described in further detail above in relation to FIG. 4.

In scenario 3, HDD system 108 is initially configured as a 512e device (i.e., processes 512-byte logical blocks and stores 4,096-byte physical blocks), and host system 102 is a system that processes 512-byte logical blocks. In this scenario, the initial configuration of HDD system 108 is compatible with host system 102. In the initial configuration, HDD system 108 is already configured to map 512-byte logical blocks of host system 102 to 4,096 physical blocks of HDD system 108, and vice versa. Therefore, the configuration of HDD system 108 is not changed.

In scenario 4, HDD system 108 is initially configured as a 512e device, and host system 102 is a system that processes 4,096-byte logical blocks. In this scenario, the initial configuration of HDD system 108 is not compatible with host system 102. HDD system 108 expects 512-byte logical blocks from host system 102, but instead, receives 5,096-byte logical blocks. Therefore, the configuration of HDD system 108 is changed such that HDD system 108 maps 4,096-byte logical blocks of host system 102 to 4,096-byte physical blocks of HDD system 108, and vice versa.

In scenario 5, HDD system 108 is initially configured as a 4K device (i.e., processes 4,096-byte logical blocks and stores 4,096 physical blocks), and host system 102 is a system that processes 512-byte logical blocks. In this scenario, the initial configuration of HDD system 108 is not compatible with host system 102. Therefore, the configuration of HDD system 108 is changed such that HDD system 108 maps 512-byte logical blocks of host system 102 to 4,096-byte physical blocks of HDD system 108, and vice versa.

In scenario 6, HDD system 108 is initially configured as a 4K device, and host system 102 is a system that processes 4,096-byte logical blocks. In this scenario, the initial configuration of HDD system 108 is compatible with host system 102. Therefore, the configuration of HDD system 108 is not changed.

Some embodiments of the disclosure may be implemented in a single device such as (without limitation) an HDD controller or a system on a chip. In some such embodiments, the single device can be selectively configurable to operate with different HDD systems. For example, the single device can be selectively configurable to operate with (i) HDD systems that store 512-byte physical blocks on each disk platter and (ii) HDD systems that store 4,096-byte physical blocks on each disk platter. As a result, the single device can selectively operate with different types of HDD systems that store differently-sized logical blocks, thereby eliminating the need to manufacture differently-designed devices that operate with different types of HDD systems.

Although embodiments of the disclosure have been described relative to entire computer systems that comprise host systems and HDD systems, and methods of operating such computer systems, embodiments of the present invention(s) are not so limited. It will be understood that the present invention(s) can be embodied in forms other than entire computer systems and methods for operating the same. For example, the present invention(s) may be embodied in components of the computer system, including (without limitation) HDD systems, HDD controllers, system on a chip, and hosts systems, and in methods implemented by these components.

Further, although embodiments of the disclosure were described as being set to an initial configuration, embodiments of the disclosure are not so limited. In alternative embodiments of the disclosure, an initial configuration is not set. In at least some such embodiments, the configuration is not set until a connection with a host is made.

Yet further, although embodiments of the disclosure were described relative to their use with 512-byte blocks and 4,096-byte blocks, embodiments of the disclosure are not so limited. Alternative embodiments of the disclosure may be implementable with block sizes or than, or in addition to, 512-byte blocks and 4,096-byte blocks.

Embodiments of the disclosure may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The invention can be embodied in the form of methods and apparatuses for practicing those methods. The invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An apparatus comprising a hard-disk drive (HDD) controller for an HDD system, wherein the HDD controller is selectively configurable to operate with a first type of host system having a first logical block size and a second type of host system having a second logical block size, different from the first logical block size.

2. The apparatus of claim 1, wherein the HDD controller is selectively configurable to:
(i) operate, if the HDD controller is connected to a host system of the first type, the HDD system to convert blocks of data between the first logical block size and a physical block size; and
(ii) operate, if the HDD controller is connected to a host system of the second type, the HDD system to convert blocks of data between the second logical block size and the physical block size.

3. The apparatus of claim 2, wherein:
the first logical block size is approximately 512 bytes;
the second logical block size is approximately 4,096 bytes; and
the physical block size is approximately 512 bytes.

4. The apparatus of claim 2, wherein:
the first logical block size is approximately 512 bytes;
the second logical block size is approximately 4,096 bytes; and
the physical block size is approximately 4,096 bytes.

5. The apparatus of claim 1, wherein the HDD controller is selectively configurable to operate with a first type of HDD system having a first physical block size and a second type of HDD system having a second physical block size, different from the first physical block size.

6. The apparatus of claim 5, wherein the HDD controller is selectively configurable to operate the HDD system in two or more of:
a first configuration, if the HDD controller is connected to a host system of the first type and an HDD system of the first type, wherein the HDD system converts blocks of data between the first logical block size and the first physical block size;
a second configuration, if the HDD controller is connected to a host system of the first type and an HDD system of the second type, wherein the HDD system converts blocks of data between the first logical block size and the second physical block size;
a third configuration, if the HDD controller is connected to a host system of the second type and an HDD system of the first type, wherein the HDD system converts blocks of data between the second logical block size and the first physical block size; and
a fourth configuration, if the HDD controller is connected to a host system of the second type and an HDD system of the second type, wherein the HDD system converts blocks of data between the second logical block size and the second physical block size.

7. The apparatus of claim 1, wherein:
the HDD controller is initially configured to operate with the first type of host system; and
the HDD controller is reconfigurable to operate with the second type of host system if the HDD controller is connected to a host system of the second type.

8. The apparatus of claim 1, wherein:
the HDD controller is configured to receive a configuration command from a host system; and
the HDD controller is configured to operate the HDD system with one of (i) the first type of host system and (ii) the second type of host system in response to the configuration command.

9. The apparatus of claim 8, wherein:
the configuration command is a FORMAT UNIT command defined in a Small Computer System Interface (SCSI) Block Commands (SBC) standard;
the FORMAT UNIT command comprises at least one field for the first and second logical block sizes; and
the HDD controller is configured to selectively operate the HDD system with one of (i) the first type of host system and (ii) the second type of host system in response to a setting of the at least one field.

10. The apparatus of claim 1, wherein the apparatus is one of (i) the HDD controller, (ii) an integrated circuit comprising the HDD controller, (iii) the HDD system comprising the HDD controller, and (iv) a computer system comprising the HDD system and the host system.

11. A method of operating a hard-disk drive (HDD) controller for an HDD system, the method comprising:
(a) determining whether the HDD controller is connected to a first type of host system having a first logical block size or a second type of host system having a second logical block size, different from the first logical block size;
(b) configuring, based on the determination in step (a), the HDD controller to operate with the first type of host system if the HDD controller is connected to a host system of the first type; and
(c) configuring, based on the determination in step (a), the HDD controller to operate with the second type of host system if the HDD controller is connected to a host system of the second type.

12. The method of claim 11, wherein:
step (b) comprises configuring the HDD system to convert blocks of data between the first logical block size and a physical block size; and
step (c) comprises configuring the HDD system to convert blocks of data between the second logical block size and the physical block size.

13. The method of claim 12, wherein:
the first logical block size is approximately 512 bytes;
the second logical block size is approximately 4,096 bytes; and
the physical block size is approximately 512 bytes.

14. The method of claim 12, wherein:
the first logical block size is approximately 512 bytes;
the second logical block size is approximately 4,096 bytes; and
the physical block size is approximately 4,096 bytes.

15. The method of claim 11, wherein the method comprises:
(1) determining whether the HDD controller is operated with a first type of HDD system having a first physical block size or a second type of HDD system having a second physical block size, different from the first physical block size;
(2) configuring, based on the determination in (1), the HDD controller to operate with the first type of HDD system if the HDD controller is connected to an HDD system of the first type; and
(3) configuring, based on the determination in (1), the HDD controller to operate with the second type of HDD system if the HDD controller is connected to an HDD system of the second type.

16. The method of claim 15, wherein the method comprises selectively configuring, based on the determinations in (a) and (1), the HDD controller to operate the HDD system in two or more of:
(i) a first configuration, if the HDD controller is connected to a host system of the first type and an HDD system of the first type, wherein the HDD system converts blocks of data between the first logical block size and the first physical block size;
(ii) a second configuration, if the HDD controller is connected to a host system of the first type and an HDD system of the second type, wherein the HDD system converts blocks of data between the first logical block size and the second physical block size;
(iii) a third configuration, if the HDD controller is connected to a host system of the second type and an HDD system of the first type, wherein the HDD system converts blocks of data between the second logical block size and the first physical block size; and
(iv) a fourth configuration, if the HDD controller is connected to a host system of the second type and an HDD system of the second type, wherein the HDD system converts blocks of data between the second logical block size and the second physical block size.

17. The method of claim 11, wherein:
the HDD controller is initially configured to operate with the first type of host system; and
the method comprises reconfiguring the HDD controller to operate with a host system of the second type if the HDD controller is connected to a host system of the second type.

18. The method of claim 11, comprising:
receiving, at the HDD controller, a configuration command from a host system; and
configuring the HDD controller to operate with one of (i) the first type of host system and (ii) the second type of host system in response to the configuration command.

19. The method of claim 18, wherein:
the configuration command is a FORMAT UNIT command defined in a Small Computer System Interface (SCSI) Block Commands (SBC) standard;
the FORMAT UNIT command comprises at least one field for the first and second logical block sizes; and
the method comprises selectively operating the HDD system with one of (i) the first type of host system and (ii) the second type of host system in response to a setting of the at least one field.
